(19) United States
(12) Patent Application Publication
(10) Pub. No.: US 2013/0148355 A1
(43) Pub. Date: Jun. 13, 2013

(54) LED BULB WITH LIQUID-COOLED DRIVE ELECTRONICS

(71) Applicant: Switch Bulb Company, Inc., San Jose, CA (US)

(72) Inventors: Ronan LE TOQUIN, Fremont, CA (US); David HORN, Saratoga, CA (US); David TITZLER, Palo Alto, CA (US)

(73) Assignee: SWITCH BULB COMPANY, INC., San Jose, CA (US)

(21) Appl. No.: 13/708,908

(22) Filed: Dec. 7, 2012

Related U.S. Application Data
(60) Provisional application No. 61/569,192, filed on Dec. 9, 2011.

(51) Int. Cl. F21V 29/00

(52) U.S. Cl. CPC F21V 29/248
USPC 362/249.02; 29/825

(57) ABSTRACT

A liquid-filled light emitting diode (LED) bulb including a stem body, a shell connected to the stem body to form an enclosed volume, and one or more LEDs attached to a support structure and disposed between the shell and the stem body. The LED bulb also includes a driver circuit configured to electrically drive the one or more LEDs. A thermally conductive liquid and a liquid-volume compensation mechanism are also disposed with the enclosed volume. The one or more LEDs and the driver circuit are thermally coupled to the thermally conductive liquid.

### CROSS REFERENCE TO RELATED APPLICATIONS

This application claims the benefit under 35 USC 119(e) of prior copending U.S. Provisional Patent Application No. 61/569,192, filed Dec. 9, 2011, the disclosure of which is hereby incorporated by reference in its entirety.

### BACKGROUND

1. Field

The present disclosure relates generally to liquid-filled light-emitting diode (LED) bulbs and, more specifically, to providing improved heat transfer from heat-generating components of the LED bulb.

2. Related Art

Traditionally, lighting has been generated using fluorescent and incandescent light bulbs. While both types of light bulbs have been reliably used, each suffers from certain drawbacks. For instance, incandescent bulbs tend to be inefficient, using only 2-3% of their power to produce light, while the remaining 97-98% of their power is lost as heat. Fluorescent bulbs, while more efficient than incandescent bulbs, do not produce the same warm light as that generated by incandescent bulbs. Additionally, there are health and environmental concerns regarding the mercury contained in fluorescent bulbs.

Thus, an alternative light source is desired. One such alternative is a bulb utilizing an LED. An LED comprises a semiconductor junction that emits light due to an electrical current flowing through the junction. Compared to a traditional incandescent bulb, an LED bulb is capable of producing more light using the same amount of power. Additionally, the operational life of an LED bulb is orders of magnitude longer than that of an incandescent bulb, for example, 10,000-100,000 hours as opposed to 1,000-2,000 hours.

While there are many advantages to using an LED bulb rather than an incandescent or fluorescent bulb, LEDs have a number of drawbacks that have prevented them from being as widely adopted as incandescent and fluorescent replacements. One drawback is that an LED, being a semiconductor, generally cannot be allowed to get hotter than approximately 150° C. As an example, A-type LED bulbs have been limited to very low power (i.e., less than approximately 8 W), producing insufficient illumination for incandescent or fluorescent replacements.

One potential solution to this problem is to use a large metallic heat sink attached to the LEDs and extending away from the bulb. However, this solution is undesirable because a large heat sink may block a portion of the light produced by the LEDs, reducing light output near the base of the bulb. A large heat sink may also make it difficult for the LED bulb to fit into pre-existing fixtures.

Another solution is to partially fill the bulb with a thermally conductive liquid to transfer heat from the LED to the shell of the bulb. The heat may then be transferred from the shell out into the air surrounding the bulb. The embodiments discussed herein are directed to techniques for transferring heat away from LED-bulb components using a thermally conductive liquid.

### SUMMARY

In one exemplary embodiment, a liquid-filled LED bulb includes a stem body, a shell connected to the stem body to form an enclosed volume, and one or more LEDs attached to a support structure and disposed between the shell and the stem body. The LED bulb also includes a driver circuit configured to electrically drive the one or more LEDs. A thermally conductive liquid is disposed with the enclosed volume. The one or more LEDs and the driver circuit are thermally coupled to the thermally conductive liquid. A liquid-volume compensation mechanism is also disposed within the enclosed volume. The liquid-volume compensation mechanism is configured to compensate for expansion of the thermally conductive liquid.

In some embodiments, the liquid-volume compensation mechanism is configured to change from a first condition to a second condition in response to thermal expansion of the thermally conductive liquid. The first condition of the liquid-volume compensation mechanism is configured to displace a first volume of liquid. The second condition of the liquid-volume compensation mechanism is configured to displace a second volume of liquid, which is less than the first volume of liquid displaced in the first condition. In some embodiments, the liquid-volume compensation mechanism is a bladder filled with a compressible medium. In some embodiments, the liquid-volume compensation mechanism is a diaphragm.

In some embodiments, at least a portion of the driver circuit directly contacts the thermally conductive liquid. In one exemplary embodiment, one or more AC components of the driver circuit are embedded in a thermally conductive potting material and one or more DC components of the driver circuit are in direct contact with the thermally conductive liquid.

In one exemplary embodiment, a driver housing is also disposed in the enclosed volume. The driver housing is attached to the support structure and encloses the driver circuit. In some cases, the driver circuit is thermally coupled to the driver housing and the driver housing is thermally coupled to the thermally conductive liquid. In some cases, the driver circuit and the driver housing are at least partially immersed in the thermally conductive liquid. The driver housing may include one or more openings to facilitate a passive convective flow of the thermally conductive liquid for cooling the driver circuit.

### DESCRIPTION OF THE FIGURES

FIG. 1 depicts a liquid-filled LED bulb.

FIGS. 2A and 2B depict an exemplary stem body of an LED bulb.

FIGS. 3A-3D depict an LED bulb at various stages of manufacture.

FIG. 4 depicts a cross-sectional view of a liquid-filled LED bulb.

FIG. 5 depicts a liquid-filled LED bulb.

FIG. 6A depicts a liquid-filled LED bulb.

FIG. 6B depicts an exploded view of an LED bulb.

FIG. 7A depicts a liquid-filled LED bulb.

FIG. 7B depicts an exploded view of an LED bulb.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Various embodiments are described below, relating to LED bulbs. As used herein, an “LED bulb” refers to any light-generating device (e.g., a lamp) in which at least one LED is used to generate the light. Thus, as used herein, an “LED bulb” does not include a light-generating device in which a filament is used to generate the light, such as a conventional incandescent light bulb. It should be recognized that the LED bulb may have various shapes in addition to the bulb-like A-type shape of a conventional incandescent light bulb. For example, the bulb may have a tubular shape, globe shape, or the like. The LED bulb of the present disclosure may further include any type of connector; for example, a screw-in base, a dual-prong connector, a standard two- or three-prong wall outlet plug, bayonet base, Edison Screw base, single pin base, multiple pin base, recessed base, flanged base, grooved base, side base, or the like.

As used herein, the term “liquid” refers to a substance capable of flowing. Also, the substance used as the thermally conductive liquid is a liquid or at the liquid state within, at least, the operating ambient temperature range of the bulb. An exemplary temperature range includes temperatures between −40° C. to +45° C. Also, as used herein, “passive convective flow” refers to the circulation of a liquid without the aid of a fan or other mechanical devices driving the flow of the thermally conductive liquid.

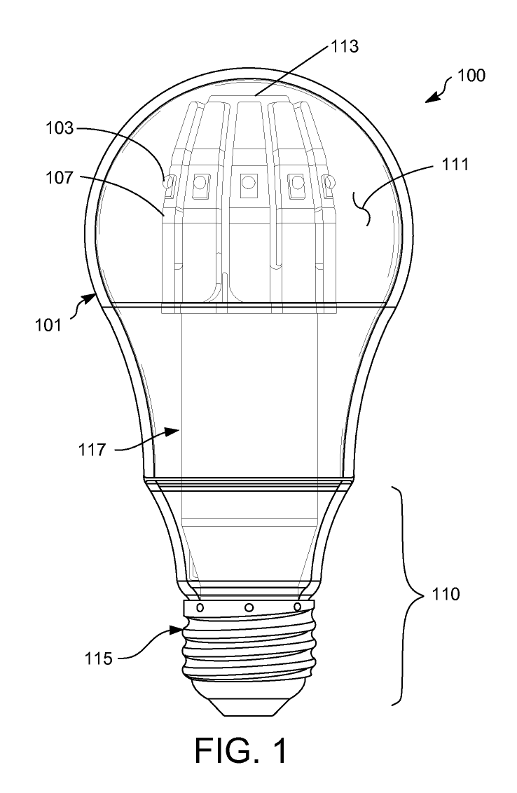

FIG. 1 depicts an exemplary liquid-filled LED bulb. As shown in FIG. 1, the LED bulb 100 includes a stem body 110 and a shell 101 encasing various components of the LED bulb 100. The shell 101 is attached to the stem body 110 forming an enclosed volume. An array of LEDs 103 is mounted to LED support structures 107 and is disposed within the enclosed volume. The enclosed volume is filled with a thermally conductive liquid 111.

Shell 101 and/or stem body 110 may be made from any transparent or translucent material such as plastic, glass, polycarbonate, or the like. Shell 101 and/or stem body 110 may include dispersion material spread throughout the shell/stem to disperse light generated by LEDs 103. The dispersion material prevents LED bulb 100 from appearing to have one or more point sources of light. In the present embodiment, the stem body 110 is made from a transparent material. However, in alternative embodiments, the stem body 110 may be made from a non-transparent plastic or metal material.

As noted above, light bulbs typically conform to a standard form factor, which allows bulb interchangeability between different lighting fixtures and appliances. Accordingly, in the present exemplary embodiment, the LED bulb 100 includes a connector base 115 for connecting the bulb to a lighting fixture. In the present example, the connector base 115 is a conventional light bulb base having threads for insertion into a conventional light socket. However, as noted above, it should be appreciated that the connector base 115 may be any type of connector for mounting the LED bulb 100 or coupling to a power source. For example, the connector base may provide mounting via a screw-in base, a dual-prong connector, a standard two- or three-prong wall outlet plug, bayonet base, Edison Screw base, single pin base, multiple pin base, recessed base, flanged base, grooved base, side base, or the like.

In some embodiments, the LED bulb 100 may use 6 W or more of electrical power to produce light equivalent to a 40 W incandescent bulb. In some embodiments, LED bulb 100 may use 20 W or more to produce light equivalent to or greater than a 75 W incandescent bulb. Depending on the efficiency of the LED bulb 100, between 2 W and 20 W of heat energy may be produced when the LED bulb 100 is illuminated.

The LED bulb 100 includes several components for dissipating the heat generated by LEDs 103. For example, as shown in FIG. 1, the LED bulb 100 includes one or more LED support structures 107 for holding the LEDs 103. The LED support structures 107 may be configured to have channels or openings between each support structure to allow the passage of fluid. Example support structures may include, but are not limited to, finger-shaped protrusions or posts. The LED support structures 107 may be made of any thermally conductive material, such as aluminum, copper, brass, magnesium, zinc, or the like. Since the LED support structures 107 may be formed of a thermally conductive material, heat generated by the LEDs 103 may be conductively transferred to LED support structures 107. Thus, the LED support structures 107 may act as a heat-sink or heat-spreader for the LEDs 103.

The LED support structures 107 are attached to the driver housing 117, which may also be made of any thermally conductive material, such as aluminum, copper, brass, magnesium, zinc, or the like, allowing heat generated by the LEDs 103 to be conducted to the driver housing 117 through the LED support structures 107. In this way, the driver housing 117 may also act as a heat-sink or heat-spreader for the LEDs 103. The LED support structures 107 and the driver housing 117 may be formed as one piece or multiple pieces.

The driver housing 117 encloses a driver circuit configured to provide current to the LEDs 103. For an exemplary driver circuit, see U.S. Pat. Nos. 8,283,877 and 8,188,671, which are incorporated herein by reference in their entirety. This or other driver circuits can be used with the LED bulb 100 and can be disposed within the driver housing 117.

In the present embodiment, the driver circuit is mechanically and thermally coupled to the driver housing 117. Specifically, at least a portion of the driver circuit is embedded in a silicone-based polymer potting material that is formulated to be thermally conductive. The thermal conductivity of the potting material typically ranges between 0.5 to 2.0 W/m K. Other potting materials, including epoxy and polyurethane materials, may also be used. By thermally coupling the driver circuit to the driver housing 117, heat generated by the driver circuit may be conducted to driver housing 117 and LED support structures 107. Thus, driver housing 117 and support structures 107 may also act as a heat-sink or heat-spreader for the driver circuit.

With reference to FIG. 1, stem body 110 may include one or more components that provide the structural features for mounting bulb shell 101 and driver housing 117. Components of the stem body 110 may include, for example, sealing gaskets, flanges, rings, adaptors, or the like. Stem body 110 may also include a connector base 115 for connecting the bulb to a power source or lighting fixture. Stem body 110 can also include one or more die-cast parts.

The LED bulb 100 is filled with a thermally conductive liquid 111 for transferring heat generated by LEDs 103 and the driver circuit to shell 101. The thermally conductive liquid 111 fills the enclosed volume defined between the shell 101 and the stem body 110, allowing the thermally conductive liquid 111 to thermally conduct with both the shell 101 and the components disposed between the shell 101 and the stem body 110. For example, in some embodiments, thermally conductive liquid 111 is in direct contact with the LEDs 103, LED support structures 107, and driver housing 117. By submerging the LEDs 103, LED support structures 107, and driver housing 117 (including the driver circuit) in the thermally conductive liquid 111, the heat transfer from the LEDs 103 and driver circuit to the thermally conductive liquid 111 (and eventually to the shell 101 and the air surrounding the LED bulb 100) can be increased. As a result, the temperature of the LED bulb 100 for a given input power can be lower than conventional (non-liquid-filled) LED bulbs.

Thermally conductive liquid 111 may include any thermally conductive liquid, mineral oil, silicone oil, glycols (PAGs), fluorocarbons, or other material capable of flowing. It may be desirable to have the liquid chosen be a non-corrosive dielectric. Selecting such a liquid can reduce the likelihood that the liquid will cause electrical shorts and reduce damage done to the components of LED bulb 100.

LED bulb 100 includes a liquid-volume compensation mechanism to allow for thermal expansion of thermally conductive liquid 111 contained in the LED bulb 100. In the present exemplary embodiment, the liquid-volume compensation mechanism is one or more bladders 113 filed with a compressible medium. For an exemplary bladder, see U.S. patent application Ser. No. 13/525,227, which is incorporated herein by reference in its entirety. In an alternative embodiment, the liquid-volume compensation mechanism includes one or more diaphragm elements. For an exemplary diaphragm element, see U.S. Pat. No. 8,152,341, which is incorporated herein by reference in its entirety.

With regard to FIG. 1, the bladder 113 is disposed in a cavity between LED support structures 107. The cavity is in fluidic connection with the enclosed volume created between shell 101 and stem body 110. The portion of the cavity that is not occupied by the bladder 113 is typically filled with the thermally conductive liquid 111. Thus, the bladder 113 is immersed in the thermally conductive liquid 111.

The bladder 113 may be made from one or more air-impermeable materials that allow for compression of the bladder 113. For example, the bladder 113 may be made from a metal foil material, a polymer material, a rubber material, or the like. In some embodiments, the bladder 113 is made from an elastic material that provides for expansion of the bladder 113 as well as compression. In one embodiment, the bladder 113 is made from a sleeve or tube material that has been sealed on both ends to create a substantially air-impermeable bladder. The bladder 113 is filled with a compressible medium including, for example, a gas, gaseous material, foam, or compressible gel. In some cases a rare gas may be used as the compressible medium to reduce permeability.

In the exemplary embodiment depicted in FIG. 1, the bladder 113 is configured to allow for thermal expansion of the thermally conductive fluid 111. For example, as LEDs 103 and the driver circuit within driver housing 117 produce heat, the temperature of the thermally conductive liquid 111 increases. As the temperature of the thermally conductive liquid 111 increases, the liquid expands and the volume of the thermally conductive liquid 111 increases. As discussed above, at least a portion of one surface of the bladder 113 is immersed in the thermally conductive liquid 111. Because the bladder 113 is in fluidic connection with the thermally conductive liquid, the bladder 113 is able to contract to compensate for an increase in volume of the thermally conductive liquid.

Typically, the bladder 113 is able to change from a first displacement condition to a second displacement condition, in response to an increase in temperature and volume of the thermally conductive liquid 111. For example, the first displacement condition may occur when the thermally conductive liquid 111 is cool (e.g., LED bulb 100 is not in operation). The second displacement condition may occur when the thermally conductive liquid 111 is warm (e.g., LED bulb 100 is in operation and has reached a steady-state temperature). Typically, the volume of the bladder in the second condition is less than the volume of the bladder in the first condition.

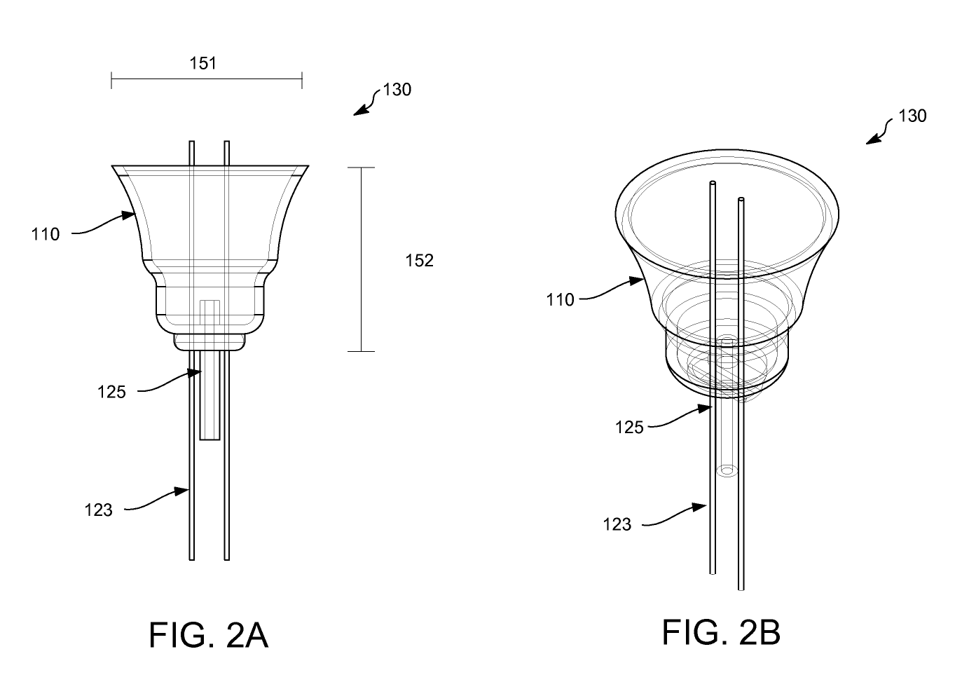

FIGS. 2A and 2B depict views of an exemplary stem 130 that may be used with LED bulb 100. Stem 130 includes stem body 110, power leads 123, and fill tube 125. Stem body 110 forms part of the enclosure for holding the thermally conductive liquid 111. In the present embodiment, the stem body 110 is made from a transparent or translucent material, such as plastic, glass, polycarbonate, or the like. As discussed above, in alternative embodiments, the stem body 110 may be made from a non-transparent plastic or metal material. In some embodiments, stem body 110 has a maximum diameter 151 between 35 and 55 mm (e.g., approximately 42 mm) and stem body 110 has a height 152 between 30 and 50 mm (e.g., approximately 40 mm).

Power leads 123 transfer power from an external power source, such as an electrical outlet, to the driver circuit within the driver housing 117. The power leads 123 are made from any electrically conductive material, such as aluminum, copper, brass, magnesium, zinc, or the like. The fill tube 125 may be used to fill LED bulb 100 with the thermally conductive fluid 111 and may be made from any liquid-impermeable material, such as plastic, glass, polycarbonate, or the like. The fill tube 125 in the present example is a single fill tube. In other embodiments, the fill tube 125 may include two or more fill tubes.

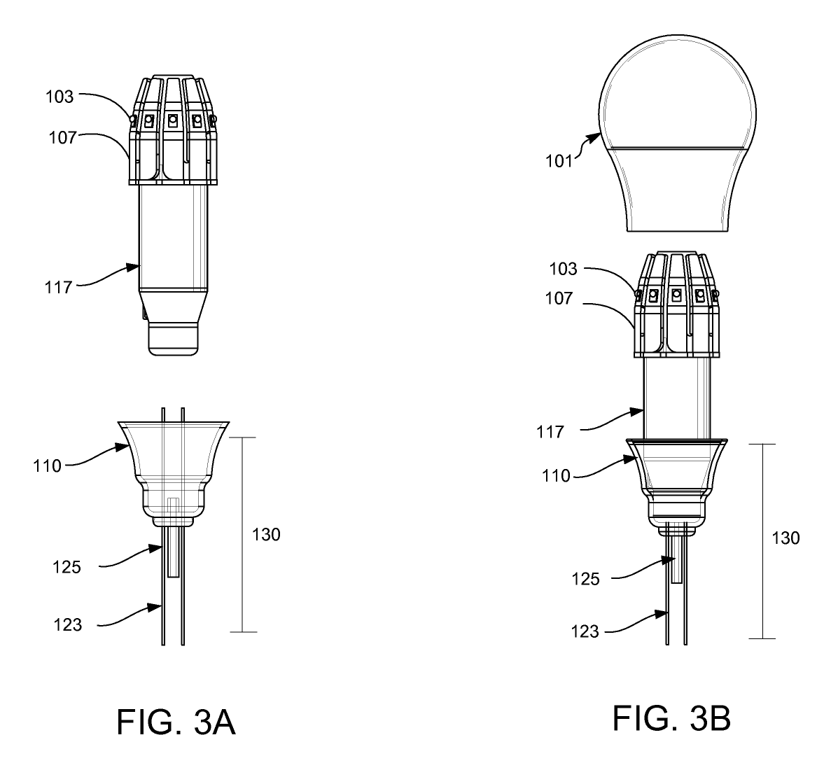

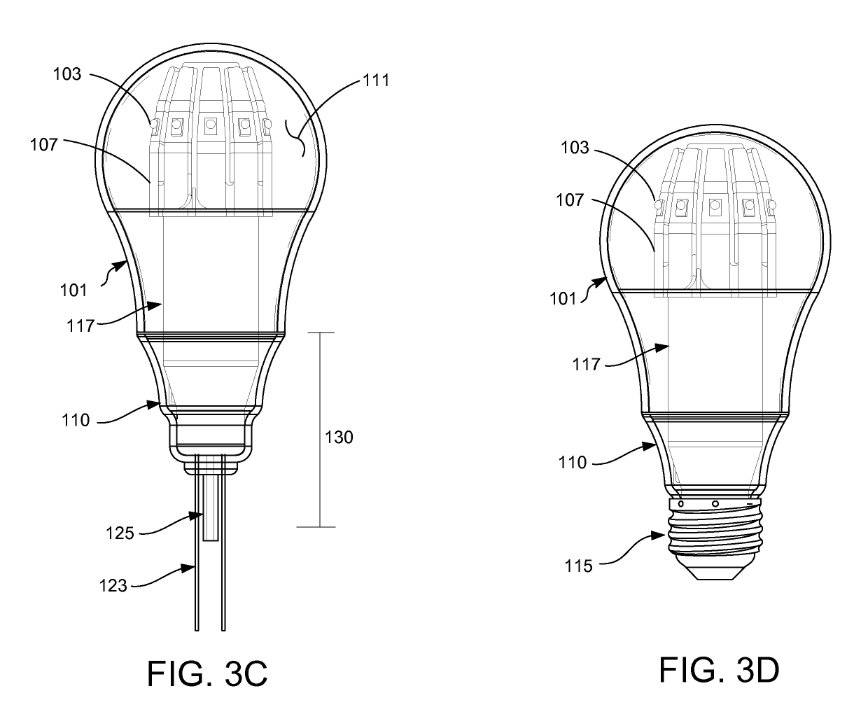

FIGS. 3A-D depict the LED bulb 100 at various stages of manufacture. As shown in FIG. 3A, the stem 130 can be coupled to the driver housing 117, which encloses the driver circuit. In this example, the power leads 123 can are electrically coupled to the driver circuit and the driver housing is mechanically coupled to the stem 130. The driver circuit is mechanically coupled to the driver housing 117 using, for example, a thermally conductive potting material. In some cases, only a portion the driver circuit is embedded in the thermally conductive potting material. In one example, the AC components of the driver circuit, including, for example, an AC filter, AC fuse, and rectifier components, are embedded in the thermally conductive potting material. In this example, the DC components, including, for example, integrated circuit components, are not embedded in the thermally conductive potting material.

Next, as shown in FIG. 3B, the shell 101 can be welded or joined to the assembly formed by the coupling of stem 130 and driver housing 117 to form a seal between the shell 101 and stem body 110. Shell 101 can be welded or joined to stem 130 and driver housing 117 using any known welding or sealing technique to prevent air from entering LED bulb 100 and to prevent thermally conductive liquid 111 from leaking out of LED bulb 100. For example, butt-welding, lap joints, frit, or the like can be used to weld or join shell 101 to stem 130 and driver housing 117.

Next, as shown in FIG. 3C, the LED bulb 100 can be filled with thermally conductive liquid 111 through fill tube 125. Once LED bulb 100 is filled with thermally conductive liquid 111, fill tube 125 can be removed and the hole left by fill tube 125 can be sealed.

Next, as shown in FIG. 3D, connector base 115 can be electrically coupled to power leads 123 and can be mechanically coupled to stem body 110.

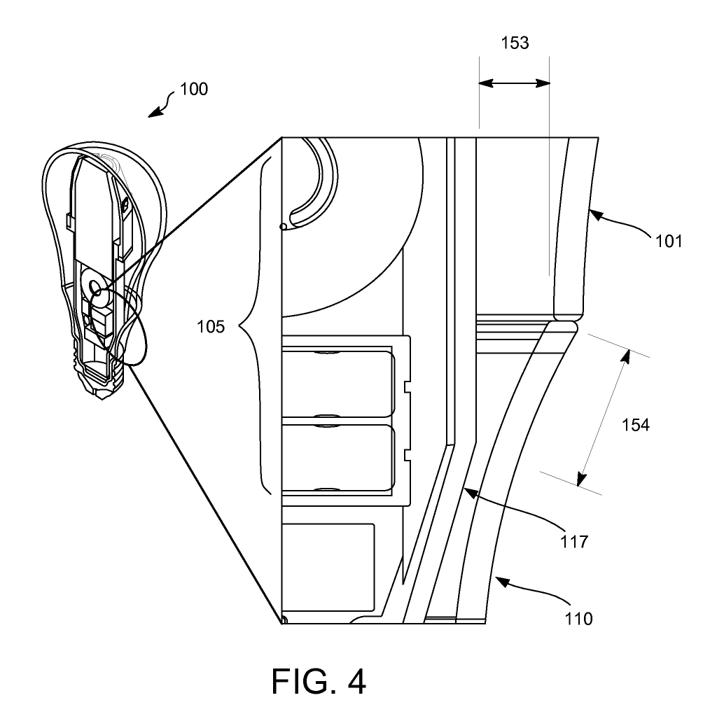

FIG. 4 depicts a more detailed cross-sectional view of LED bulb 100. As shown in FIG. 4, the components of LED bulb 100 can be configured such that a portion of the thermally conductive liquid 111 is disposed between the driver housing 117 and shell 101. In the present embodiment, a portion of the thermally conductive liquid 111 disposed between the driver housing 117 and shell 101 is able to transfer heat from the driver housing 117 via passive convection. As shown in FIG. 4, a width 153 is formed between the driver housing 117 and shell 101 and a distance 154 is formed along an edge of stem body 110. The components may be configured such that the width 153 and distance 154 are large to enough facilitate passive convective currents in the portion of the thermally conductive liquid 111 disposed between the driver housing 117 and shell 101.

In some embodiments, the width 153 and distance 154 are also configured to prevent the temperature of shell 101 (or other temperature-sensitive component) from exceeding a desired maximum value. The desired maximum value can be selected based on the material of shell 101 (e.g., melting temperature of shell 101) and/or temperatures that are safe or comfortable for human touch. In some embodiments, width 153 and distance 154 can be configured to limit the temperature of shell 101 to approximately 120° C. during normal operation of LED bulb 100. However, other maximum temperature values can be used depending on the desired application. One of ordinary skill in the art can determine the width 153 and distance 154 (or other dimension) required to limit the temperature of shell 101 (or other temperature sensitive component) to a desired maximum value.

As shown in FIG. 4, the driver circuit 105 is located within driver housing 117. In some embodiments, driver housing 117 can be a fully-sealed housing that prevents driver circuit 105 from directly contacting thermally conductive liquid 111. In a sealed housing embodiment, the driver circuit 105 can be thermally coupled to driver housing 117 by, for example, a thermally conductive potting material. Generally, the heat generated by the driver circuit 105 is conducted through the driver housing 117 and into the thermally conductive liquid 111.

In other embodiments, the driver housing 117 is not sealed with respect to the thermally conductive liquid 111. That is, the thermally conductive liquid 111 fills at least a portion of the housing and is in direct contact with the driver circuit 105 resulting in at least a portion of the driver circuit 105 being immersed in the thermally conductive liquid 111. For example, driver housing 117 may include one or more holes or channels through which the thermally conductive liquid 111 can enter the driver housing 117. In such an embodiment, driver circuit 105 may or may not be thermally coupled to driver housing 117 via other conductive materials or heat conduits, such as a thermally conductive potting material.

In yet other embodiment, the driver circuit is immersed in the thermally conductive liquid, but not enclosed in a driver housing. For example, the LED bulb may include a central support structure, such as a hollow or fully filled cylinder, disposed at approximately the center of the bulb and having the driver circuitry attached to the outer surface of the central support structure.

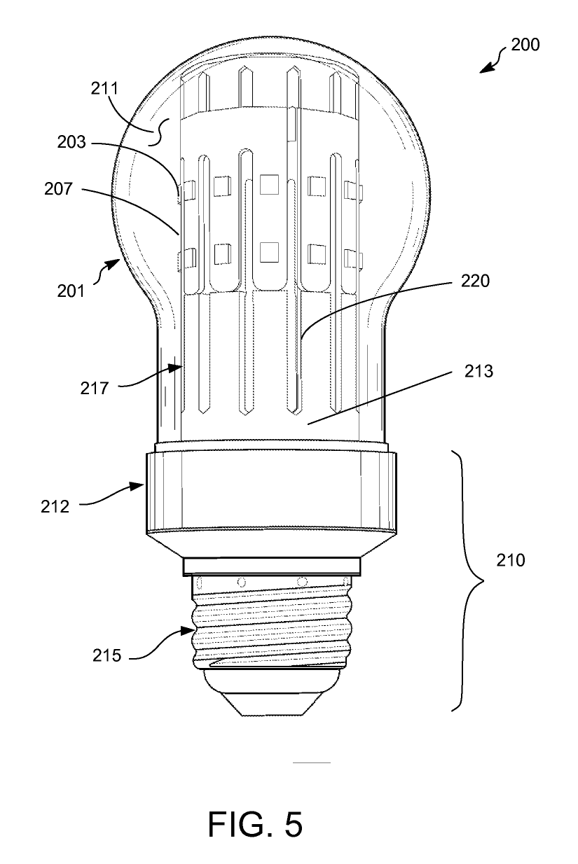

FIG. 5 depicts another exemplary embodiment of a liquid-filled LED bulb. As shown in FIG. 5, LED bulb 200 includes a stem body 210 and a shell 201 encasing various components of LED bulb 200. The shell 201 is attached to the stem body 210 forming an enclosed volume. An array of LEDs 203 is mounted to an LED support structure 207 and is disposed within the enclosed volume. The enclosed volume is filled with a thermally conductive liquid 211. As discussed above, the thermally conductive liquid 211 may include any thermally conductive liquid, mineral oil, silicone oil, glycols (PAGs), fluorocarbons, or other material capable of flowing.

Shell 201 may be made from any transparent or translucent material such as plastic, glass, polycarbonate, or the like, and may include dispersion material spread throughout the shell 201 to disperse light generated by LEDs 203. The stem body 210 may also be made, in part, from transparent or translucent materials. In this embodiment, the stem body 210 is partially covered with dress ring 212 made from a non-transparent, polycarbonate material.

As noted above, light bulbs typically conform to a standard form factor, which allows bulb interchangeability between different lighting fixtures and appliances. Accordingly, in the present exemplary embodiment, LED bulb 200 includes connector base 215 for connecting the bulb to a lighting fixture.

Similar to the LED bulb 100 described above, the LED bulb 200 includes several components for dissipating the heat generated by LEDs 203. Specifically, as shown in FIG. 5, LED bulb 200 includes an LED support structure 207 for mounting LEDs 203. In FIG. 5, the LED support structure 207 is formed from a single piece of material having multiple flange portions for mounting pairs of LEDs 203. Between each flange portion there is a channel or opening to provide a path for a flow of the thermally conductive liquid 211. The LED support structure 207 in this example is made from a composite laminate material that includes electrical traces for providing power to the LEDs 203 and a thermally conductive material, such as aluminum, copper, brass, magnesium, zinc, or the like.

As shown in FIG. 5, the LED support structure 207 is attached to driver housing 217, which may also be made of a thermally conductive material, such as aluminum, copper, brass, magnesium, zinc, or the like. Heat generated by LEDs 203 may be conducted to driver housing 217 through LED support structure 207. In this way, driver housing 217 may also act as a heat-sink or heat-spreader for LEDs 203. The driver housing 217 may be formed as one piece or multiple pieces.

As discussed above with respect to other embodiments, driver housing 217 may enclose a driver circuit configured to provide current to LEDs 203. The driver circuit may be mechanically and thermally coupled to the driver housing 217 via a thermally conductive potting material, as described above with respect to FIGS. 3A-D. Heat generated by the driver circuit may be conducted to driver housing 217, which also acts as a heat-sink or heat-spreader for the driver circuit.

The thermally conductive liquid 211 that fills the LED bulb 200 assists in the transfer of heat generated by the LEDs 203 and the driver circuit to the shell 201. Specifically, the thermally conductive liquid 211 fills the enclosed volume defined between shell 201 and stem body 210, allowing the thermally conductive liquid 211 to thermally conduct with both the shell 201 and the components disposed between shell 201 and stem body 210.

As shown in FIG. 5, the driver housing 217 includes a plurality of vertical channels 220 that provide a path for a flow of the thermally conductive liquid 211. Thus, in the present embodiment, the thermally conductive liquid 211 is in direct contact with LEDs 203, LED support structure 207, driver housing 217 and the driver circuit. Stated another way, at least a portion of the driver circuit and the LEDs 203 are immersed in the thermally conductive liquid 211. The thermally conductive liquid 211 is able to conduct heat directly away from the surfaces of these components. In some embodiments, the thermally conductive liquid 211 is also able to transfer heat away from the LEDs 203 and driver circuit by passive convection.

Because the LEDs 203 and driver circuit are immersed in the thermally conductive liquid 211, the heat transfer from the LEDs 203 and driver circuit to thermally conductive liquid 211 (and eventually to shell 201 and the air surrounding LED bulb 200) can be increased. As a result, the temperature of LED bulb 200 for a given input power can be lower than more conventional LED bulbs.

LED bulb 200 includes a liquid-volume compensation mechanism to allow for thermal expansion of thermally conductive liquid 211 contained in the LED bulb 200. In the present embodiment, the liquid-volume compensation mechanism 213 includes one or more bladders and/or one or more diaphragm elements. The liquid-volume compensation mechanism 213 is located within the driver housing 217 and is in fluidic connection with the enclosed volume created between shell 201 and stem body 210.

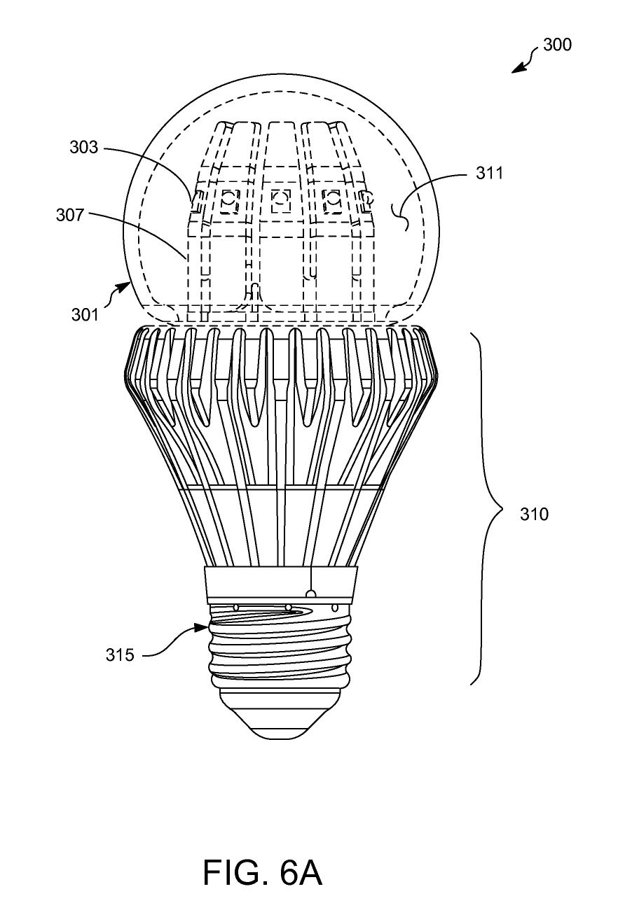

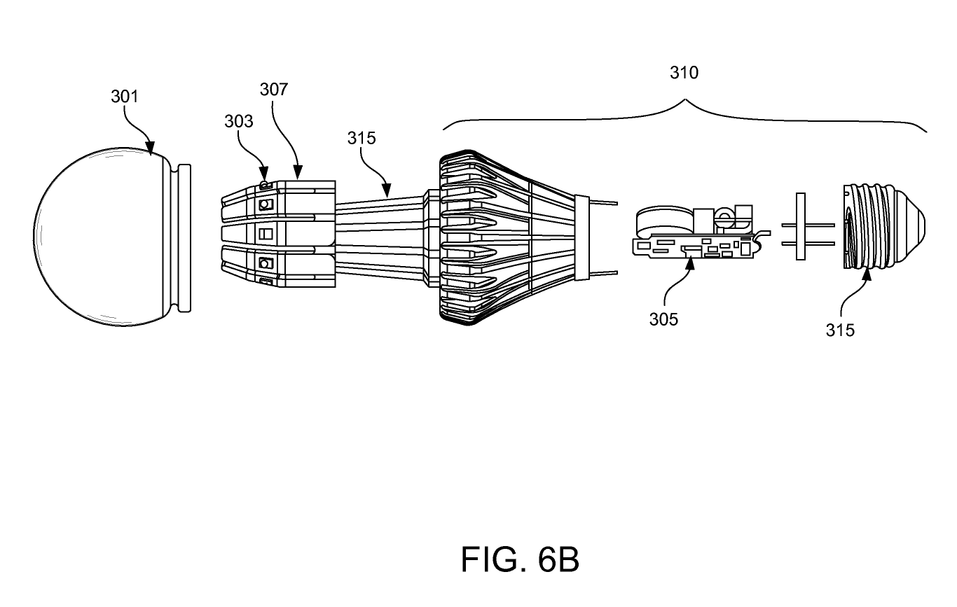

FIGS. 6A and 6B depict another embodiment of a liquid-filled LED bulb. As shown in FIGS. 6A and 6B, LED bulb 300 includes a base 310 and a shell 301 encasing various components of LED bulb 300. The shell 301 is attached to the base 310 forming an enclosed volume. An array of LEDs 303 is mounted to LED support structures 307 and is disposed within the enclosed volume. The enclosed volume is filled with a thermally conductive liquid 311. As discussed above, the thermally conductive liquid 311 may include any thermally conductive liquid, mineral oil, silicone oil, glycols (PAGs), fluorocarbons, or other material capable of flowing.

Shell 301 may be made from any transparent or translucent material such as plastic, glass, polycarbonate, or the like, and may include dispersion material spread throughout the shell 301 to disperse light generated by LEDs 303.

As noted above, light bulbs typically conform to a standard form factor, which allows bulb interchangeability between different lighting fixtures and appliances. Accordingly, in the present exemplary embodiment, LED bulb 300 includes connector base 315 for connecting the bulb to a lighting fixture.

Similar to the LED bulbs 100 and 200, described above, the LED bulb 300 includes several components for dissipating the heat generated by LEDs 303. Specifically, as shown in FIGS. 6A and 6B, LED bulb 300 includes LED support structures 307 for mounting LEDs 303. In FIGS. 6A and 6B, the LED support structures 307 are formed from multiple flange portions. Between each flange portion there is a channel or opening to provide a path for a flow of the thermally conductive liquid 311. The LED support structures 307 in this example are made from a composite laminate material that includes electrical traces for providing power to the LEDs 303 and a thermally conductive material, such as aluminum, copper, brass, magnesium, zinc, or the like.

As shown in FIG. 6B, LED support structures 307 are attached to the base 310 via hub 315, which may also be made of a thermally conductive material, such as aluminum, copper, brass, magnesium, zinc, or the like. Heat generated by LEDs 303 may be conducted to the hub 315 through LED support structures 307. In this way, hub 315 may also act as a heat-sink or heat-spreader for LEDs 303. The hub 315 and base 310 may be formed as one piece or multiple pieces.

The base 310 encloses a driver circuit 305 configured to provide current to LEDs 303. Heat generated by the driver circuit 305 may be conducted to the base 310, which also acts as a heat-sink or heat-spreader for the driver circuit 305. As previously described, a thermally conductive potting material may be used to mechanically and thermally couple the driver circuit 305 in, for example, an enclosure or cavity of the base 310.

The thermally conductive liquid 311 that fills the LED bulb 300 assists in the transfer of heat generated by the LEDs 303 and the driver circuit 305 to the shell 301 (and other portions of the LED bulb 300 that are exposed to the surrounding environment). Specifically, the thermally conductive liquid 311 fills the enclosed volume defined between the shell 301 and base 310 and also fills the portion of the base 310 that contains the driver circuit 305. Thus, both the LEDs 303 and the driver circuit 305 are at least partially immersed in the thermally conductive liquid 311.

Because the liquid is in direct contact with heat-generating components, the thermally conductive liquid 311 provides additional heat transfer away from LEDs 303 and the driver circuit 305 via passive convection and conduction. For example, heat may be transferred from the LEDs 303 and the driver circuit 305 directly into the thermally conductive liquid via passive convection. Heat may also be transferred into the thermally conductive liquid 311 through other components that are in thermal connection with the LEDs 303 and the driver circuit 305, such as the base 310 and LED support structures 307. Heat transferred into the thermally conductive liquid 311 is eventually transferred to the shell 301 and the surrounding environment. As a result, the temperature of LED bulb 300 for a given input power may be lower than a conventional, non-liquid LED bulb.

LED bulb 300 also includes a liquid-volume compensation mechanism to allow for thermal expansion of thermally conductive liquid 311 contained in the LED bulb 300. In the present embodiment, the mechanism is a diaphragm. The diaphragm is placed in a cavity located within the base 310, which is in fluidic connection with the enclosed volume created between shell 301 and the base 310. The diaphragm is typically formed from one or more membrane materials. The diaphragm may also include one or more piston elements and guide rod elements to support the membrane material.

Typically, at least one side of the diaphragm is in contact with the thermally conductive liquid 311 and at least one other side is vented to the outside air. As the temperature of the thermally conductive liquid 311 increases, the liquid expands and the volume of the thermally conductive liquid 311 increases. In response to the increase in volume of the thermally conductive liquid 311, the diaphragm deforms and compensates for the additional liquid volume.

Typically, the diaphragm is able to change from a first displacement condition to a second displacement condition, in response to an increase in temperature and volume of the thermally conductive liquid 311. As discussed above with respect to previous embodiments, the first displacement condition may occur when the thermally conductive liquid 311 is cool (e.g., LED bulb 300 is not in operation). The second displacement condition may occur when the thermally conductive liquid 311 is warm (e.g., LED bulb 300 is in operation and has reached a steady-state temperature). The volume displaced by the diaphragm in the first condition is typically greater than the volume displaced by the diaphragm in the second condition.

In an alternative embodiment, one or more bladders can be used as the liquid-volume compensation mechanism in place of the diaphragm. In this alternative embodiment, one or more bladders would be disposed within a cavity of the base 310 that is in fluidic connection with the enclosure formed by the shell 301 and base 310. As described above with respect to LED bulb 100, because the bladder is at least partially immersed in the thermally conductive liquid 311, the bladder is able to contract to compensate for an increase in liquid volume.

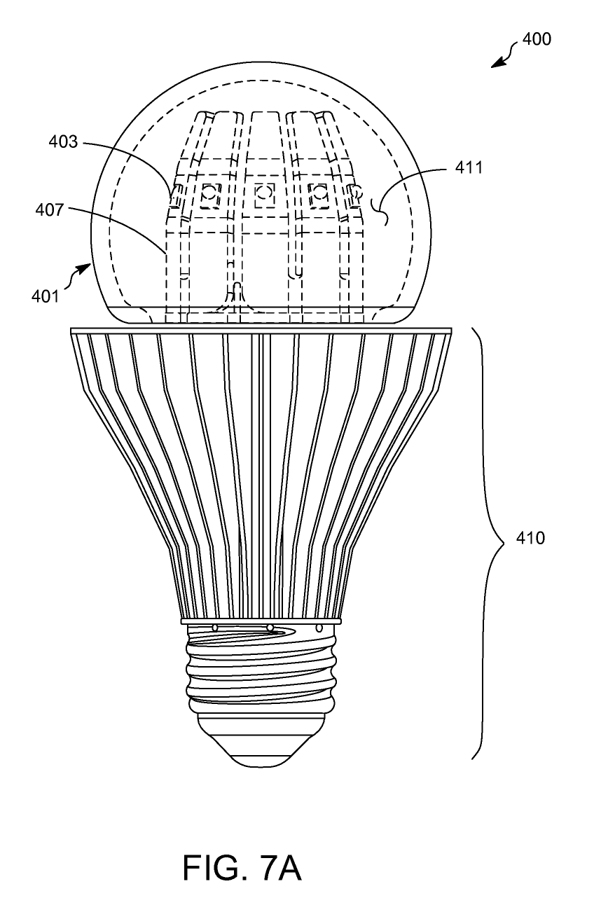

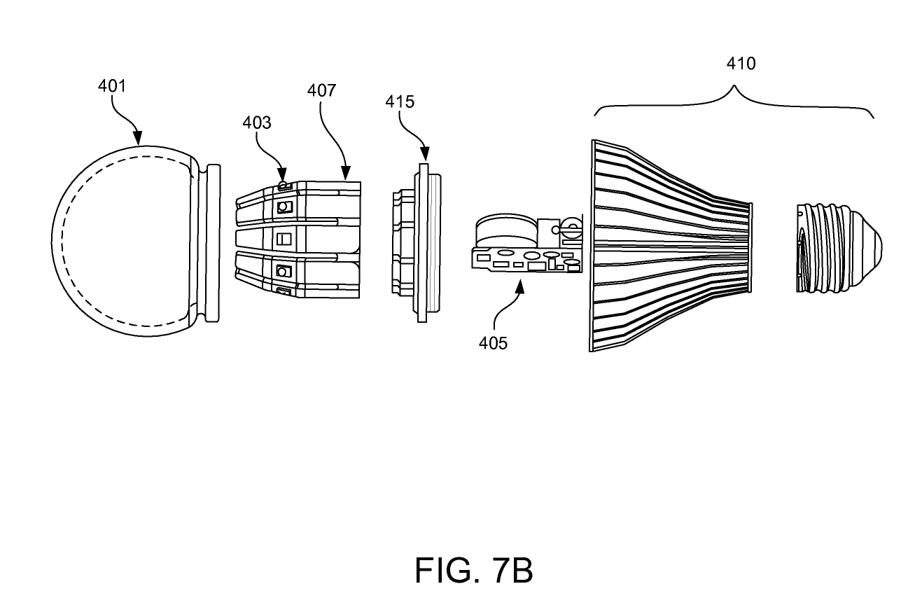

FIGS. 7A and 7B depict another embodiment of a liquid-filled LED bulb. As shown in FIGS. 7A and 7B, LED bulb 400 includes a base 410 and a shell 401 encasing various components of LED bulb 400. The shell 401 is attached to the base 410 forming an enclosed volume. An array of LEDs 403 is mounted to LED support structures 407 and is disposed within the enclosed volume. The enclosed volume is filled with a thermally conductive liquid 411.

Similar to the LED bulb 300 described above, the LED bulb 400 includes several components for dissipating the heat generated by LEDs 403. Specifically, as shown in FIGS. 7A and 7B, LED bulb 400 includes LED support structures 407 formed from multiple flange portions. Between each flange portion there is a channel or opening to provide a path for a flow of the thermally conductive liquid 411.

As shown in FIG. 7B, LED support structures 407 are attached to the base 410 via hub 415, which may also be made of a thermally conductive material, such as aluminum, copper, brass, magnesium, zinc, or the like. Heat generated by LEDs 403 may be conducted through the support structures 407, through the hub 415, and eventually to the base 410. The hub 415 and base 410 may be formed as one piece or multiple pieces.

As shown in FIGS. 7A and 7B, the base 410 is formed from multiple fins extending radially from a central body portion. The body portion of the base 410 encloses a driver circuit 405 configured to provide current to LEDs 403. Heat generated by the driver circuit 405 may be conducted to the base 410, which also acts as a heat-sink or heat-spreader for the driver circuit 405. As previously described, a thermally conductive potting material may be used to mechanically and thermally couple the driver circuit 405 in, for example, the body portion of the base.

As discussed with respect to previous embodiments, the thermally conductive liquid 411 that fills the LED bulb 400 assists in the transfer of heat generated by the LEDs 403 and the driver circuit 405 to the shell 401. Specifically, the thermally conductive liquid 411 fills the enclosed volume defined between the shell 401 and base 410 and also fills the portion of the base 410 that contains the driver circuit 405. Thus, both the LEDs 403 and the driver circuit 405 are at least partially immersed in the thermally conductive liquid 411.

Because the thermally conductive liquid 411 is in direct contact with heat-generating components, the thermally conductive liquid 411 provides additional heat transfer away from LEDs 403 and the driver circuit 405 via passive convection and conduction. For example, heat may be transferred from the LEDs 403 and the driver circuit 405 directly into the thermally conductive liquid via passive convection. As a result, the temperature of LED bulb 400 for a given input power may be lower than a conventional, non-liquid LED bulb.

LED bulb 400 also includes a liquid-volume compensation mechanism to allow for thermal expansion of thermally conductive liquid 411 contained in the LED bulb 400. Either a bladder or a diaphragm can be used as a liquid-volume compensation mechanism. The liquid-volume compensation mechanism is typically disposed in the body portion of the base 410.

Although a feature may appear to be described in connection with a particular embodiment, one skilled in the art would recognize that various features of the described embodiments may be combined. Moreover, aspects described in connection with an embodiment may stand alone.

We claim:

1. A liquid-filled light-emitting diode (LED) bulb comprising:
a stem body;
a shell connected to the stem body to form an enclosed volume;
one or more LEDs attached to a support structure and disposed between the shell and the stem body;
a driver circuit configured to electrically drive the one or more LEDs;
a thermally conductive liquid disposed within the enclosed volume, wherein the one or more LEDs and the driver circuit are thermally coupled to the thermally conductive liquid; and
a liquid-volume compensation mechanism disposed within the enclosed volume, wherein the liquid-volume compensation mechanism is configured to compensate for expansion of the thermally conductive liquid.

2. The liquid-filled LED bulb of claim 1, wherein the driver circuit is cooled by passive convective currents in the thermally conductive liquid.

3. The liquid-filled LED bulb of claim 1,
wherein the liquid-volume compensation mechanism is configured to change from a first condition to a second condition in response to thermal expansion of the thermally conductive liquid;
wherein the first condition of the liquid-volume compensation mechanism is configured to displace a first volume of liquid; and
wherein the second condition of the liquid-volume compensation mechanism is configured to displace a second volume of liquid, which is less than the first volume of liquid displaced in the first condition.

4. The liquid-filled LED bulb of claim 1, wherein the liquid-volume compensation mechanism is a bladder filled with a compressible medium.

5. The liquid-filled LED bulb of claim 1, wherein the liquid-volume compensation mechanism is a diaphragm.

6. The liquid-filled LED bulb of claim 1, wherein at least a portion of the driver circuit directly contacts the thermally conductive liquid.

7. The liquid-filled LED bulb of claim 1, wherein one or more AC components of the driver circuit are embedded in a thermally conductive potting material and one or more DC components of the driver circuit are in direct contact with the thermally conductive liquid.

8. The liquid-filled LED bulb of claim 1, further comprising:
a driver housing, wherein the driver housing is attached to the support structure, and wherein the driver housing encloses the driver circuit.

9. The liquid-filled LED bulb of claim 8, wherein the driver circuit is thermally coupled to the driver housing and the driver housing is thermally coupled to the thermally conductive liquid.

10. The liquid-filled LED bulb of claim 8, wherein the driver circuit and the driver housing are at least partially immersed in the thermally conductive liquid.

11. The liquid-filled LED bulb of claim 8, wherein the driver housing includes one or more openings to facilitate a passive convective flow of the thermally conductive liquid for cooling the driver circuit.

12. A method of making a liquid-filled light-emitting diode (LED) bulb, the method comprising:
obtaining one or more LEDs;
electrically coupling the one or more LEDs to a driver circuit that is configured to electrically drive the one or more LEDs;
coupling the driver circuit to one or more leads, wherein the one or more leads are disposed within a stem body;
installing a liquid-volume compensation mechanism in a driver housing attached to the stem body, wherein the liquid-volume compensation mechanism is configured to compensate for expansion of the thermally conductive liquid;
connecting a shell to the stem body to form an enclosed volume; and
filling the enclosed volume with the thermally conductive liquid, wherein after filling, the one or more LEDs and the driver circuit are thermally coupled to the thermally conductive liquid.

13. The method of claim 12, wherein after filling the enclosure, the one or more LEDs and the driver circuit are at least partially immersed in the thermally conductive liquid.

14. The method of claim 12, wherein the driver circuit is disposed within a driver housing, and wherein after filling the enclosure, the driver circuit is thermally coupled to the thermally conductive liquid through the driver housing.

15. The method of claim 14, further comprising, embedding at least a portion of the driver circuit in a thermally conductive potting material within the driver housing.

16. The method of claim 15, wherein one or more AC components of the driver circuit are embedded in the thermally conductive potting material and one or more DC components of the driver circuit are not embedded in the thermally conductive potting material and are at least partially immersed in the thermally conductive liquid.

17. A liquid-filled light-emitting diode (LED) bulb comprising:
a base;
a shell connected to the base to form an enclosed volume;
a thermally conductive liquid disposed within the enclosed volume;
one or more LEDs disposed within the enclosed volume;
a driver circuit disposed within the enclosed volume and at least partially immersed in the thermally conductive liquid, the driver circuit configured to electrically drive the one or more LEDs; and
a liquid-volume compensation mechanism disposed within the enclosed volume and in contact with the thermally conductive liquid, wherein the liquid-volume compensation mechanism is configured to compensate for expansion of the thermally conductive liquid.

18. The liquid-filled LED bulb of claim 17, wherein the driver circuit is cooled by passive convective currents in the thermally conductive liquid.

19. The liquid-filled LED bulb of claim 17,
wherein the liquid-volume compensation mechanism is configured to change from a first condition to a second condition in response to thermal expansion of the thermally conductive liquid;
wherein the first condition of the liquid-volume compensation mechanism is configured to displace a first volume of liquid; and
wherein the second condition of the liquid-volume compensation mechanism is configured to displace a second volume of liquid, which is less than the first volume of liquid displaced in the first condition.

20. The liquid-filled LED bulb of claim 17, wherein the liquid-volume compensation mechanism is a bladder filled with a compressible medium.

21. The liquid-filled LED bulb of claim 17, wherein the liquid-volume compensation mechanism is a diaphragm.

22. The liquid-filled LED bulb of claim 17, wherein one or more AC components of the driver circuit are embedded in a thermally conductive potting material and one or more DC components of the driver circuit are in direct contact with the thermally conductive liquid.

23. A method of making a liquid-filled light-emitting diode (LED) bulb, the method comprising:
obtaining one or more LEDs electrically coupled to a driver circuit that is configured to electrically drive the one or more LEDs;
coupling the driver circuit to one or more leads, wherein the one or more leads are disposed within a base;
installing a liquid-volume compensation mechanism in the base, wherein the liquid-volume compensation mechanism is configured to compensate for expansion of a thermally conductive liquid;
connecting a shell to the base to form an enclosed volume, wherein the one or more LEDs and the driver circuit are disposed within the enclosed volume; and
filling the enclosed volume with the thermally conductive liquid, wherein after filling, the one or more LEDs and the driver circuit are at least partially immersed in the thermally conductive liquid.

24. The method of claim 23, further comprising, embedding at least a portion of the driver circuit in a thermally conductive potting material within the base.

25. The method of claim 23, wherein one or more AC components of the driver circuit are embedded in the thermally conductive potting material and one or more DC components of the driver circuit are not embedded in the thermally conductive potting material and are at least partially immersed in the thermally conductive liquid.
